(19) United States
(12) Patent Application Publication
(10) Pub. No.: US 2021/0049526 A1
(43) Pub. Date: Feb. 18, 2021

(54) Risk analysis through mapping

(71) Applicant: Vouch, Inc., San Francisco, CA (US)

(72) Inventors: Evan Roman, San Francisco, CA (US); Travis Hedge, Burlingame, CA (US); John Wallace, Chicago, IL (US)

(73) Assignee: Vouch, Inc., San Francisco, CA (US)

(21) Appl. No.: 16/873,907

(22) Filed: Aug. 6, 2020

Related U.S. Application Data
(60) Provisional application No. 62/922,562, filed on Aug. 15, 2019.

(51) Int. Cl. G06Q 10/06; G06Q 40/08; G06K 9/62

(52) U.S. Cl. CPC G06Q 10/0635; G06K 9/6202; G06K 9/6215; G06Q 40/08

(57) ABSTRACT

The present invention is generally directed to systems and methods for risk analysis through mapping. It is more specifically directed to systems and methods for risk analysis through mapping certain company features in relation to business insurance. In one case, the present invention provides a method of determining a risk pattern. The method comprises the steps of: inputting different risk scenarios into a database; subjecting the risk scenarios to a risk pattern analysis using one or more ontologically-based algorithms to generate a set of predetermined risk patterns; storing the set of predetermined risk patterns in a database; subjecting a set of normalized risk scores to the risk pattern analysis to generate a second risk pattern; comparing the second risk pattern to the set of predetermined risk patterns to provide a similarity value; using the similarity value and a threshold value to determine whether the second risk pattern matches a member of the set of predetermined risk patterns, thereby determining the risk pattern.

### FIELD OF THE INVENTION

The present invention is generally directed to systems and methods for risk analysis through mapping. It is more specifically directed to systems and methods for risk analysis through mapping certain company features in relation to business insurance.

### BACKGROUND OF THE INVENTION

There have been reports of risk analysis involving mapping. For instance, U.S. Pat. Pub. No. US 2011/0054961, entitled “Adaptive Risk Analysis Engine”, allegedly reports the following: “A method for characterizing risk using an adaptive risk analysis engine. Following a user request for a risk analysis, online and/or offline factual information is retrieved by the engine and is used to produce risk indicators. The risk indicators are mapped onto risk ontology to produce risk factors which are then used to assess the level of risk. Parameters for the likelihood, impact, and external threat of the risk are calculated, and a risk assessment report is produced for the user.” Abstract.

U.S. Pat. Pub. No. US 2016/0379326, entitled “Risk Modeling System”, allegedly reports the following: “The system provides early warning intelligence feeds which analyze risks of potential human caused threats and naturally caused hazards. It includes data mining functions that autonomously search and categorize threats/hazards from worldwide open source data on a continuing basis. Data comes from many news feeds, social media feeds, government databases, etc. Key word analyses allow potential threats/hazards to be sorted into categories traditionally used by government agencies. Physical and cybersecurity vulnerabilities are analyzed and measured with threats to disclose potential impacts to people, properties, processes, special events, and related critical infrastructures and industries. Overall risk scores are instantly displayed as color coded icons on a worldwide electronic map/dashboard at any geolocation. Daily Intelligence reports and certain immediate alerts are also produced.” Abstract.

US 2019/0050942, entitled “Systems and Methods for Dynamic Real-Time Analysis from Multi-Modal Data Fusion for Contextual Risk Identification”, allegedly reports the following: “Disclosed is a system and method to automatically identify property-related risks through the use of computer vision, sensors, and/or building information models (BIMs). The ability to automatically identify a variety of hazards helps mitigate the associated risks, and thus reduces the number of accidents or fatalities that would otherwise occur. In some embodiments, a “risk map” can be generated by mapping the identified risks for a given property.” Abstract.

Despite the various reports, there is still a need in the art for novel systems and methods for risk analysis through mapping.

### SUMMARY OF THE INVENTION

In one case, the present invention provides a method of determining a risk pattern. The method comprises the steps of: inputting different risk scenarios into a database; subjecting the risk scenarios to a risk pattern analysis using one or more ontologically-based algorithms to generate a set of predetermined risk patterns; storing the set of predetermined risk patterns in a database; subjecting a set of normalized risk scores to the risk pattern analysis to generate a second risk pattern; comparing the second risk pattern to the set of predetermined risk patterns to provide a similarity value; using the similarity value and a threshold value to determine whether the second risk pattern matches a member of the set of predetermined risk patterns, thereby determining the risk pattern.

In another case, the present invention provides a computer system for risk assessment. The computer system includes one or more processors and one or more storage devices having stored thereon computer-executable instructions. The instructions are executable by the one or more processors to cause the computer system to: accept data related to different risk scenarios into a database, wherein the data is inputted by a user; subject the risk scenario data to a risk pattern analysis using one or more ontologically-based algorithms to provide a set of predetermined risk patterns that are stored in a database; subject a set of normalized risk scores to the risk pattern analysis to generate a second risk pattern; compare the second risk pattern to the set of predetermined risk patterns to provide a similarity value; use the similarity value and a threshold value to determine whether the second risk pattern matches a member of the set of predetermined risk patterns, thereby determining the risk pattern.

In another case, the present invention provides one or more hardware storage devices having stored thereon computer-executable instructions. The instructions are executable by one or more processors of a computing system to cause the computer system to: accept data related to different risk scenarios into a database, wherein the data is inputted by a user; subject the risk scenario data to a risk pattern analysis using one or more ontologically-based algorithms to provide a set of predetermined risk patterns that are stored in a database; subject a set of normalized risk scores to the risk pattern analysis to generate a second risk pattern; compare the second risk pattern to the set of predetermined risk patterns to provide a similarity value; use the similarity value and a threshold value to determine whether the second risk pattern matches a member of the set of predetermined risk patterns, thereby determining the risk pattern.

### BRIEF DESCRIPTION OF THE DRAWINGS

FIG. 1 is a flow diagram illustrating an exemplary method of risk assessment (100).

FIG. 2 is a flow diagram illustrating an exemplary method of mapping risk assessment (200).

FIG. 3 is a flow diagram illustrating a method of providing an insurance rate to a user (300).

FIG. 4 is a flow diagram illustrating a method of decreasing risk, and conversely increasing a company's health (400).

FIG. 5 is an illustration of an exemplary computer readable medium where processor-executable instructions are configured to embody one or more of the provisions set forth herein may be comprised.

FIG. 6 illustrates an exemplary computing environment wherein one or more of the provisions set forth herein may be implemented.

### DETAILED DESCRIPTION OF THE INVENTION

The present invention is generally directed to systems and methods for risk analysis through mapping. It is more specifically directed to systems and methods for risk analysis through mapping certain company features in relation to business insurance.

Nonlimiting examples of business risks include: strategic risk; compliance risk; operational risk; reputational risk; implementation risk; pervasiveness risk; and preparedness risk.

“Strategic risk” refers to the risk that failed business decisions, or lack thereof, may pose to a company. Tools one can use to minimize strategic risk include, without limitation: business plan guidelines/templates; guidelines/checklists for retaining one or more outside advisors (e.g., scientific/technical advisory board); guidelines/checklists for retaining one or more board members; guidelines/templates/checklists for scenario planning; guidelines/checklists for establishing a competitive intelligence program.

“Compliance risk” refers to exposure to legal penalties, financial forfeiture and material loss an organization faces when it fails to act in accordance with industry laws and regulations, internal policies or prescribed best practices. Tools one can use to minimize compliance risks include, without limitation: guidelines/templates/checklists for a compliance audit; guidelines/checklists for establishing searches directed to changing laws or legal frameworks applicable to the subject business.

“Operational risk” refers to the risk of a change in value caused by the fact that actual losses, incurred for inadequate or failed internal processes, people and systems, or from external events, differ from the expected losses. Tools one can use to minimize operational risks include, without limitation: guidelines/templates/checklists for clauses within various contract types (e.g., indemnification, liability limitation and warranty clauses); guidelines/templates/checklists directed to processes for protecting intellectual property; guidelines/templates/checklists directed to documentation of manufacturing and/or development processes; guidelines/templates/checklists for cybersecurity processes.

“Reputational risk” refers to the potential loss to financial capital, social capital and/or market share resulting from damages to a company's reputation. Tools one can used to minimize reputational risk include, without limitation: guidelines/templates/checklists for employee, manager, officer, director and strategic advisor use of social media; guidelines/templates/checklists for establishing searches directed to company reputation; guidelines/templates/checklists for surveying key partners and/or customers.

“Implementation risk” refers to the potential for a development or deployment failure. The term is often used for risks related to a production launch. Tools one can use to minimize implementation risk include, without limitation: guidelines/templates/checklists for establishment of project management with respect to key projects; guidelines/templates/checklists for project audits; guidelines/templates/checklists for training employees charged with project tasks.

“Pervasiveness risk” refers to the effects on the financial report of misstatements or the possible effects on the financial report of misstatements, if any, that are undetected due to an inability to obtain sufficient appropriate audit evidence. Tools one can use to minimize pervasiveness risk include, without limitation: guidelines/templates/checklists for audits of internal control systems; guidelines/templates/checklists for financial control systems.

“Preparedness risk” refers to effects on the company related to the preparation for and reduction of effects resulting from disasters. Tools one can use to minimize preparedness risk include, without limitation: guidelines/templates/checklists for establishing an emergency preparedness program; guidelines/templates/checklists for an emergency plan; guidelines/templates/checklists for a hazard vulnerability assessment.

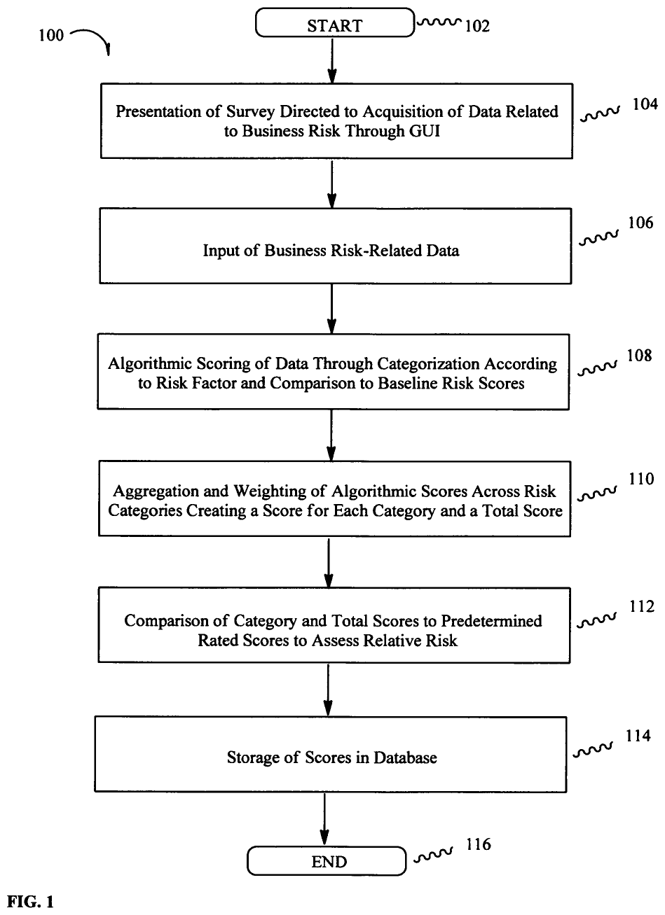

Embodiments of the present invention are described in reference to the drawings, where reference numbers are generally used to refer to elements throughout. FIG. 1 is a flow diagram illustrating an exemplary method of risk assessment (100). At 102, the method starts. At 104, a survey directed to the acquisition of date related to business risk is presented to a user through a graphical user interface. Nonlimiting examples of such data include: whether or not the user's company has a business plan; if there is a business plan, its primary provisions; whether or not the user's company has outside advisors; if there are outside advisors, their primary qualifications; whether or not the user's company has a board of directors; if there are directors, their primary qualifications; whether or not the user's company has a competitive intelligence program; if there is a competitive intelligence program, primary aspects of that program; whether or not the user's company has done or will do a compliance audit; if there has been or will be a compliance audit, the primary aspects of the audit; whether or not the user's company has established a program to monitor changing laws or legal frameworks applicable to the subject business; if the company has a monitoring program, primary aspects of the program; the number of employees at the user's company; whether or not the user's company has a program in place to protect intellectual property; if the company has an intellectual property program in place, its primary aspects; whether or not the user's company has a contract review program in place; if a contract review program exists, its primary aspects; whether or not the user's company has documented research/development/manufacturing processes; if the company has documented research/development/manufacturing processes, their primary aspects; whether or not the user's company has a program in place to monitor the company's reputation; if a reputation monitoring program exists, its primary aspects; whether or not the user's company has a program in place to monitor employee, manager, officer, director and advisor reputations; if a reputation monitoring program exists for employees, managers, officers, directors and advisors, its primary aspects; whether or not the user's company has a program in place to monitor the reputation of key partners and customers; if a reputation monitoring program exists for partners and customers, its primary aspects; whether or not the user's company has guidelines/templates/checklists for project management; if the company has project management guidelines/templates/checklists, their primary aspects; whether or not the user's company has guidelines/templates/checklists for project audits; if the company has project audit guidelines/templates/checklists, their primary aspects; whether or not the company has a program for training employees for project tasks; if the company has a program for training employees for project tasks, its primary aspects; whether or not the user's company has a program for internal control system audits; if the company has a program for internal control system audits, its primary aspects; whether or not the user's company has a financial control system program; if the company does have a financial control system program, its primary aspects; whether or not the user's company has an emergency preparedness program; if the company has an emergency preparedness program, its primary aspects; whether or not the user's company has guidelines/templates/checklists for a hazard vulnerability assessment; if the company has guidelines/templates/checklists for a hazard vulnerability assessment, its primary aspects.

At 106, the user enters business risk-related data into the appropriate fields of the graphical user interface, from which it is entered into a database. At 108, the data in the database is algorithmically scored by comparing the entered data to predetermined values. The scoring may be of any suitable form, e.g., numerical, high/medium/low, etc. For instance, it may have been predetermined that a particular company should have a competitive intelligence program in place. If the company does not have such a program in place, and numerical scoring is used, it would receive a “0” as a score for that risk assessment piece. A further example, if the company has a competitive intelligence program, but it only has five aspects when it is predetermined it should have ten, the company would receive a “5” as a score.

At 110, the algorithmic scores from 108 are aggregated and weighted across risk categories, creating a score for each category and a total score. For instance, again where numerical scores are used instead of another method such as high/medium/low scoring, the company could receive scores of 8, 0 and 5 for strategic risk, scores of 7, 2 and 3 for compliance risk, scores of 4, 2 and 10 for operational risk, scores of 3, 2 and 1 for reputational risk, scores of 10, 9 and 5 for implementation risk, scores of 8, 7 and 9 for pervasiveness risk, and scores of 6, 4 and 8 for preparedness risk. If so, the category scores could be: 13 for strategic risk; 12 for compliance risk; 16 for operational risk; 6 for reputational risk; 24 for implementation risk; 24 for pervasiveness risk; and 18 for preparedness risk. The total risk score could accordingly be 113.

At 112, the category and total scores are compared to predetermined category and total scores to normalize them. At 114, the normalized scores are stored in a database. At 116, the method ends.

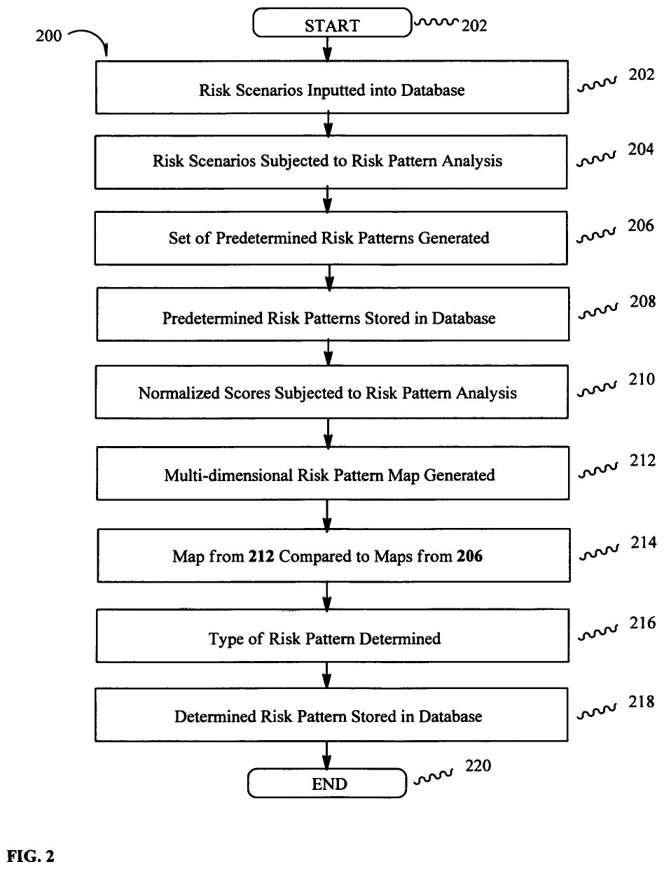

FIG. 2 is a flow diagram illustrating an exemplary method of mapping risk assessment (200). At 202, the method starts. At 204, different risk scenarios (i.e., different combinations of normalized risk scores) are inputted into a database. At 206, the different risk scenarios are subjected to risk pattern analysis using one or more ontologically-based algorithms, generating a set of predetermined risk patterns at 208, which are typically multi-dimensional maps (e.g., three dimensional maps) having individual nodes representing different kinds of risk (e.g., general or specific reputational risk). At 210, the set of predetermined risk patterns are stored in the database. At 212, the normalized scores from step 114 of the previously discussed method are subjected to the risk pattern analysis, and a multi-dimensional map is generated for those scores at 214. At 216, the risk pattern analysis is used to compare the map from 214 with the maps from 208 to determine similarity values, e.g., a numerical value representing the summed value of a node-by-node distance comparison. Examples of methods to determine and compare node distances include, Euclidean and normalized squared Euclidean distances and Manhattan distances. At 218, using a predetermined threshold value, whether the map of 214 represents a particular type of risk pattern is determined. At 220, the determined risk pattern is stored in a database. At 222, the method ends.

In certain cases, the method of mapping risk assessment uses algorithmic and/or aggregated and weighted scores that are tailored for startup companies. For instance, scores related to operational/reputational risk such as the following may be used: indicators of investor operational/reputational strength, such as amount of investment funds managed and return on investment; indicators of founder operational/reputational strength, such as amount of previous investment funds secured and market cap of previous ventures; indicators of manager operational/reputational strength, such as number of reports at prior companies and value of previously managed projects.

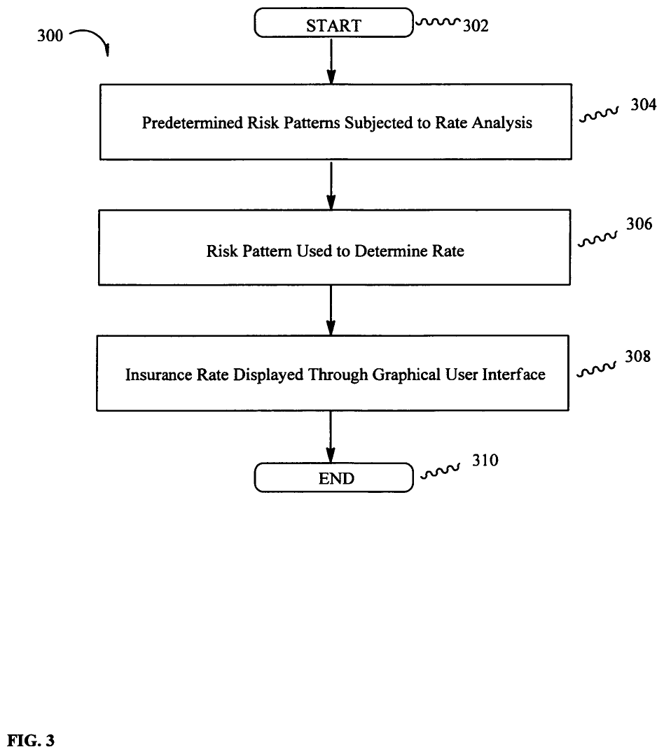

FIG. 3 is a flow diagram illustrating a method of providing an insurance rate to a user (300). At 302, the method starts. At 304, the database-stored, predetermined risk patterns from 210 are subjected to a rate analysis using a rate analysis algorithm, which assigns an insurance rate to each pattern. At 306, the particular risk pattern stored in 220 is used to determine an insurance rate, by comparing it to the data generated in 304. At 308, the determined insurance rate is displayed through a graphical user interface to the user of 104. At 310, the method ends.

Through the methods of the present invention, a user of 104 can obtain an insurance rate in less than 10 minutes. In certain cases, the user can obtain the insurance rate in less than 7.5 minutes, less than 5.0 minutes, less than 2.5 minutes or less than 1.0 minutes.

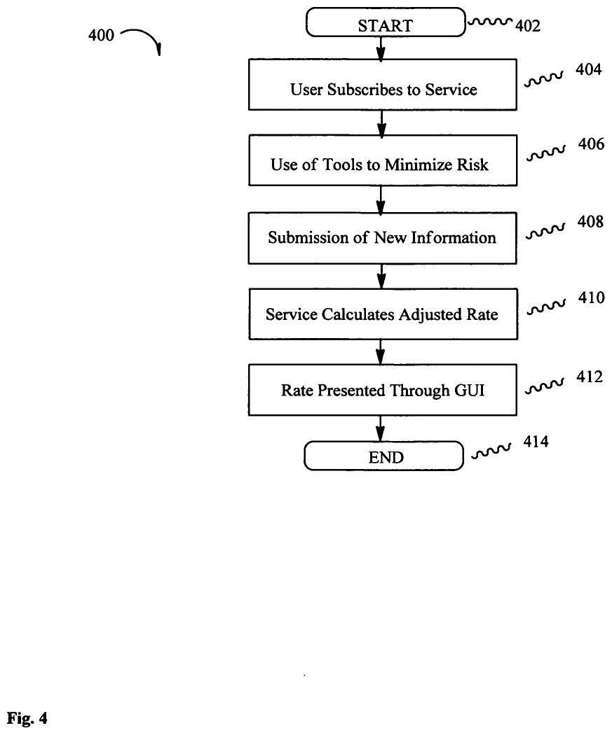

FIG. 4 is a flow diagram illustrating a method of decreasing risk, and conversely increasing a company's health (400). At 402, the method starts. At 404, a user subscribes to a service providing access to the methods of 100, 200 and 300. At 406, the user, or another company representative or representatives, use of tools to minimize certain risks (e.g., one or more of strategic risk, compliance risk, operational risk, reputational risk, implementation risk, pervasiveness risk and preparedness risk). At 408, the user or other representative submits risk minimization-related data to the service. At 410, the service calculates the adjusted rate using the methods of 100, 200 and 300 and presents it to the user through a graphical user interface (412). At 414, the method ends.

Through the method of FIG. 4, a company can decrease its risk calculated by methods of the present invention by more than 5 percent. In certain cases, the company can decrease its risk by more than 10 percent, more than 15 percent, more than 20 percent, more than 25 percent, more than 30 percent, more than 35 percent, more than 40 percent, more than 45 percent or more than 50 percent.

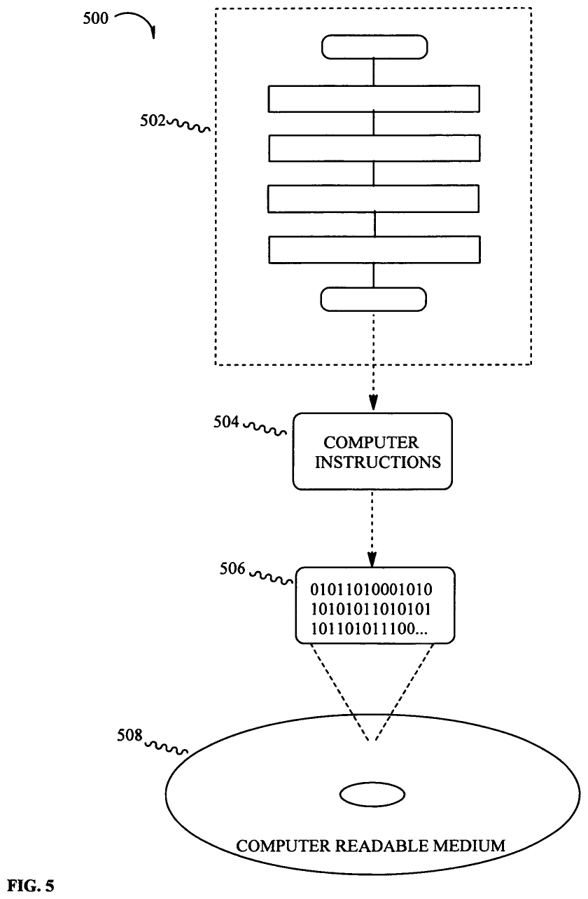

Still another embodiment involves a computer-readable medium comprising processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, such as at least some of the exemplary methods 100 of FIG. 1, 200 of FIG. 2, 300 of FIG. 3 or 400 of FIG. 4, for example. In some embodiments, the processor-executable instructions 504 are configured to implement a system. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

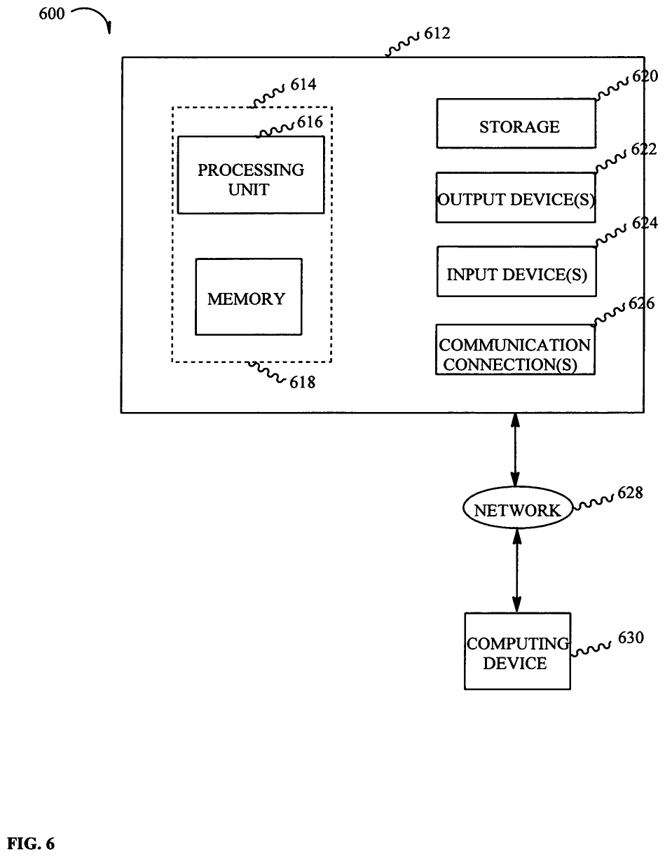

FIG. 6 illustrates an exemplary computing environment wherein one or more of the provisions set forth herein may be implemented. This figure and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

1. A method of determining a risk pattern, wherein the method comprises the steps of:
inputting different risk scenarios into a database;
subjecting the risk scenarios to a risk pattern analysis using one or more ontologically-based algorithms to generate a set of predetermined risk patterns;
storing the set of predetermined risk patterns in a database;
subjecting a set of normalized risk scores to the risk pattern analysis to generate a second risk pattern;
comparing the second risk pattern to the set of predetermined risk patterns to provide a similarity value;
using the similarity value and a threshold value to determine whether the second risk pattern matches a member of the set of predetermined risk patterns thereby determining the risk pattern.

2. A computer system for risk assessment, comprising: one or more processor; and one or more storage devices having stored thereon computer-executable instructions, which are executable by the one or more processors to cause the computer system to: accept data related to different risk scenarios into a database, wherein the data is inputted by a user; subject the risk scenario data to a risk pattern analysis using one or more ontologically-based algorithms to provide a set of predetermined risk patterns that are stored in a database; subject a set of normalized risk scores to the risk pattern analysis to generate a second risk pattern; compare the second risk pattern to the set of predetermined risk patterns to provide a similarity value; use the similarity value and a threshold value to determine whether the second risk pattern matches a member of the set of predetermined risk patterns, thereby determining the risk pattern.

3. One or more hardware storage devices having stored thereon computer-executable instructions, which are executable by one or more processors of a computing system to cause the computer system to: accept data related to different risk scenarios into a database, wherein the data is inputted by a user; subject the risk scenario data to a risk pattern analysis using one or more ontologically-based algorithms to provide a set of predetermined risk patterns that are stored in a database; subject a set of normalized risk scores to the risk pattern analysis to generate a second risk pattern; compare the second risk pattern to the set of predetermined risk patterns to provide a similarity value; use the similarity value and a threshold value to determine whether the second risk pattern matches a member of the set of predetermined risk patterns, thereby determining the risk pattern.
